(19) United States
(12) Patent Application Publication
(10) Pub. No.: US 2020/0243941 A1
(43) Pub. Date: Jul. 30, 2020

(54) FOLDABLE BROADBAND ANTENNA

(71) Applicant: Innovation Sound Technology Co., Ltd, Shenzhen, Guangdong (CN)

(72) Inventors: Shun Ming Yuen, Shenzhen, Guangdong (CN); Wai Yin Mung, Shenzhen, Guangdong (CN); Ka Ming Wu, Shenzhen, Guangdong (CN)

(21) Appl. No.: 16/089,457

(22) PCT Filed: Aug. 23, 2018
(86) PCT No.: PCT/CN2018/101990

§ 371 Date: Sep. 28, 2018

(30) Foreign Application Priority Data
Aug. 16, 2018 (CN) 201810933801.1

(51) Int. Cl. H01Q 1/08; H01Q 1/12; H01Q 1/38

(52) U.S. Cl. CPC H01Q 1/08; H01Q 1/38; H01Q 1/1207

(57) ABSTRACT

Provided is a foldable broadband antenna. The antenna includes two thin metal sheets that are flexible, thus the broadband antenna is bendable and can conform to a planar or curved surface. Thus, the antenna can either installed on a PCB or installed on other substrate. By adjusting the length of the thin metal sheet, different operation frequencies of the antenna can be obtained. Thus, it is possible to design an antenna with different sizes according to specific requirements, thereby the broadband antenna according to embodiments of the disclosure can be used together with different radio techniques, such as GPS, Bluetooth, ZigBee, cellular communications and the like.

### TECHNICAL FIELD

The disclosure relates to the technical field of wireless transmission, and in particular to a foldable broadband antenna.

### BACKGROUND

The Internet of Things (IoT) involves data interconnection and exchange between devices and/or sensors. At present, with the explosive development of IoT techniques, increasing applications can be found in various fields, including security, asset tracking, agriculture, smart metering, smart city, smart home and the like. IoT applications have specific requirements, such as long distance, low data rate, low energy consumption and cost efficiency. Known short-range radio techniques (such as ZigBee, Bluetooth) are not suitable for scenarios of long-distance transmission. The technical solution based on cellular communications (such as 2G, 3G and 4G) may provide larger coverage, but they consume too much energy. The disclosure thus proposes a broadband antenna, which combine with ZigBee, Bluetooth and cellular communications to implement emission and reception.

### SUMMARY

Embodiments of the disclosure are intended to provide a foldable broadband antenna, so as to solve the technical problem described in the Background section above.

To this end, a technical solution according to an embodiment of the disclosure is provided as follows.

There is provided a foldable broadband antenna, including two thin metal sheets and signal input terminals, herein the two thin metal sheets are made of flexible metal, and different operation frequencies of the broadband antenna are obtained by changing a length of each of the two thin metal sheets.

In an embodiment, the signal input terminals may include a positive input terminal and a negative input terminal, and the positive input terminal and the negative input terminal are soldered respectively to bottom portions of the two thin metal sheets.

In an embodiment, a thin metal sheet soldered to the negative input terminal has a circuit arranged on a back side of the thin metal sheet.

In an embodiment, the thin metal sheets are thin silver-plated aluminium sheets.

Compared to the prior art, beneficial effects of the embodiments of the disclosure are as follows.

1. The broadband antenna according to an embodiment of the disclosure includes two thin metal sheets that are flexible, thus the broadband antenna is bendable and can conform to a planar or curved surface. Thus, the antenna can either installed on a PCB or installed on other substrate.

2. By adjusting the length of the thin metal sheet, different operation frequencies of the antenna can be obtained. Thus, it is possible to design an antenna with different sizes according to specific requirements, thereby the broadband antenna according to embodiments of the disclosure can be used together with different radio techniques, such as GPS, Bluetooth, ZigBee, cellular communications and the like.

### BRIEF DESCRIPTION OF THE DRAWINGS

FIG. 1 is a schematic structural diagram of a patch antenna according to an embodiment of the disclosure.

FIG. 2 is a schematic structural diagram showing a broadband antenna according to an embodiment of the disclosure, which is installed and conforming to a curved surface.

FIG. 3 is a schematic diagram showing simulation results of return loss of an antenna with different lengths according to an embodiment of the disclosure.

FIG. 4 is a schematic diagram showing test and simulation results of an antenna according to an embodiment of the disclosure.

### DETAILED DESCRIPTION

Technical solutions according to embodiments of the disclosure will be described clearly and completely below with references to the accompanying drawings of the embodiments. It is apparent that the described embodiments are only part of the embodiments of the disclosure rather than all of the embodiments. All other embodiments obtained by those skilled in the art without inventive efforts based on the embodiments of the disclosure fall within the scope of protection of the disclosure.

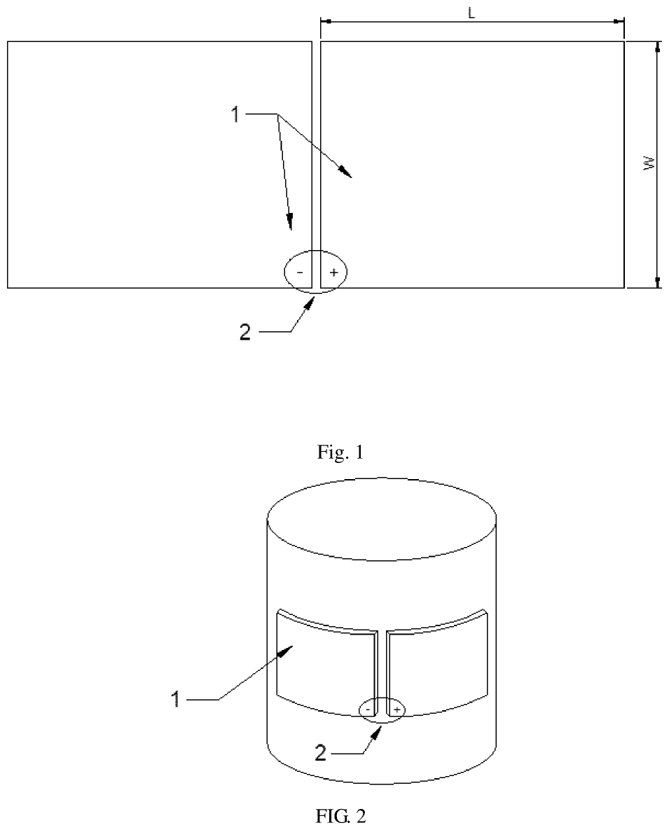

Referring to FIG. 1 and FIG. 2, a foldable broadband antenna is provided. The antenna includes two thin metal sheets 1 and signal input terminals 2. The thin metal sheets 1 are made of flexible metal, such as thin silver-plated aluminium sheets. The thin metal sheets are flexible, thus the broadband antenna is bendable and can conform to a planar or curved surface. Thus, the antenna can either installed on a PCB or installed on other substrate. The signal input terminals 2 include a positive input terminal and a negative input terminal, and the positive input terminal and the negative input terminal are soldered respectively to bottom portions of the two thin metal sheets 1. A thin metal sheet 1 soldered to the negative input terminal has a circuit arranged on a back side of the thin metal sheet.

Each of the thin metal sheets 1 has a length L and a width W. By adjusting the length L, different operation frequencies of the broadband antenna can be obtained.

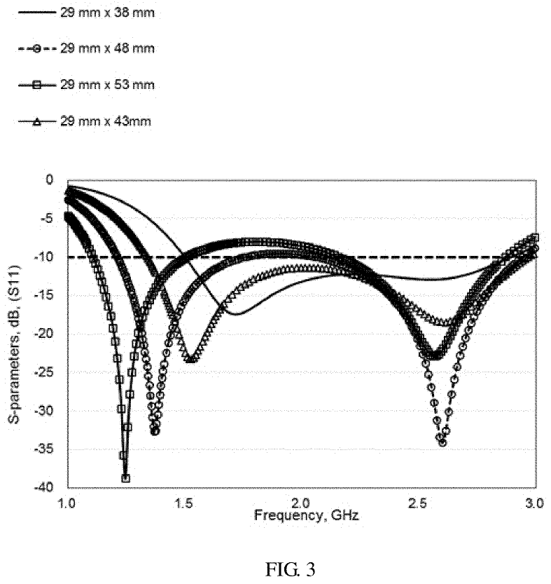

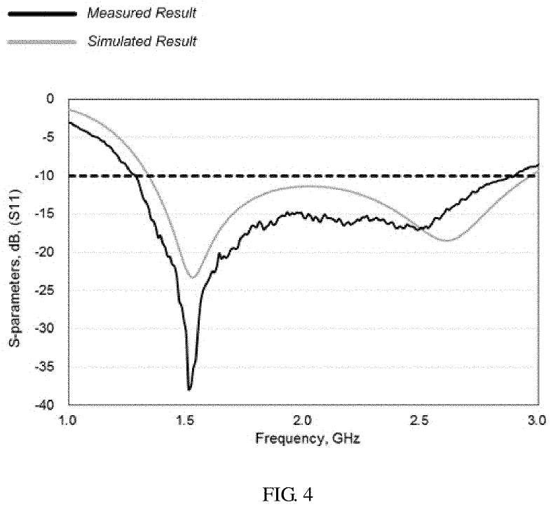

FIG. 3 shows simulation results of return loss of an antenna with a same width W (29 mm) and different lengths L (38 mm, 48 mm, 53 mm and 43 mm). The return loss represent a resonance frequency of the antenna. FIG. 4 shows test and simulation results of a broadband antenna with L=43 mm and w=29 mm.

When L=38 mm, the broadband antenna has a highest operation frequency. As can be seen from the simulation results, the smaller L is, the higher the operation frequency is. Thus, the antenna may cover different radio frequencies. Thus, it is possible to design an antenna with different sizes according to specific requirements, thereby the broadband antenna according to embodiments of the disclosure can be used together with different radio techniques, such as GPS, Bluetooth, ZigBee, cellular communications and the like.

Those skilled in the art will appreciate that the disclosure is not limited to the details as described in the above exemplary embodiments, and the technical solutions of the disclosure can be implemented in other specific manner without departing from the spirits or basic features of the disclosure. From every point of view, the embodiments as described are exemplary only and are not limiting. The scope of the disclosure is indicated by the appended claims rather than by the foregoing description, and all changes which come within the meaning and range of equivalency of the claims are therefore intended to be embraced therein. Any reference signs in the claims shall not be construed as limiting the claim concerned.

In addition, it is to be noted that description is made based on specific embodiments, but it does not mean that each embodiment only includes an independent technical solution, and such description is only made for the sake of clarity. Those skilled in the art should appreciate the description in its entirety. Technical solutions according to various embodiments of the disclosure can be combined appropriately so as to obtain other embodiments that can be conceived by those skilled in the art.

1. A foldable broadband antenna, comprising two thin metal sheets (1) and signal input terminals (2), wherein the two thin metal sheets (1) are made of flexible metal, and different operation frequencies of the broadband antenna are obtained by changing a length of each of the two thin metal sheets (1).

2. The foldable broadband antenna according to claim 1, wherein the signal input terminals (2) comprise a positive input terminal and a negative input terminal, and the positive input terminal and the negative input terminal are soldered respectively to bottom portions of the two thin metal sheets (1).

3. The foldable broadband antenna according to claim 2, wherein a thin metal sheet (1) soldered to the negative input terminal has a circuit arranged on a back side of the thin metal sheet.

4. The foldable broadband antenna according to claim 1, wherein the thin metal sheets (1) are thin silver-plated aluminium sheets.

5. The foldable broadband antenna according to claim 2, wherein the thin metal sheets (1) are thin silver-plated aluminium sheets.

6. The foldable broadband antenna according to claim 3, wherein the thin metal sheets (1) are thin silver-plated aluminium sheets.
